(19) United States
(12) Patent Application Publication
(10) Pub. No.: US 2005/0097074 A1
(43) Pub. Date: May 5, 2005

(54) Built-in apparatus, HTTP request distribution method, recording medium for storing implementation program and Web system

(76) Inventors: Ryuuhei Deno, Kanagawa (JP); Manabu Nakamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/940,966

(22) Filed: Sep. 15, 2004

(30) Foreign Application Priority Data
Sep. 19, 2003 (JP) 2003-329078

(51) Int. Cl. G06F 7/00; G06F 17/30

(52) U.S. Cl. 707/1

(57) ABSTRACT

A built-in apparatus, a HTTP request distribution method, a recording medium for storing a program to implement the method, and a Web system are disclosed. The built-in apparatus includes a first distribution part distributing a process corresponding to a HTTP request to a Web application associated with an application path of URL in the HTTP request and a second distribution part distributing the process to a process function associated with a URL path of the URL in the Web application. According to the present invention, it is possible to not only prevent performance reduction by decreasing workloads on a server program due to association of URLs with process functions but also provide various controls based on information other than URL.

### BACKGROUND OF THE INVENTION

1. Field of the Invention

The present invention relates to a built-in apparatus, a HTTP request distribution method, a recording medium for storing a program to implement the method and a Web system.

2. Description of the Related Art

In conventional Web servers, a Web page is implemented in form of a file, and URL (Uniform Resource Locator) is managed under file-base management. Also, CGI (Common Gateway Interface) is likewise managed under file-base management, and dynamically determined values are processed by giving parameters to files.

However, in a WWW (World Wide Web) server operable in a so-called “built-in apparatus” such as an image forming apparatus, which can be differentiated from an ordinary information processing apparatus such as a personal computer and a server in that the built-in apparatus includes OS (Operating System) and applications, a Web page is usually implemented as a process function rather than a file for the purpose of saving resources thereof. Thus, when a built-in apparatus receives a HTTP request having URL and a process function from a HTTP client (browser), the built-in apparatus has to manage the URL and the process function in a server program in such a way that the URL is associated with the process function.

Japanese Laid-Open Patent Application No. 10-173890 discloses a facsimile apparatus as a built-in apparatus implementing a WWW server. The facsimile apparatus, in response to receipt of an instruction from an external PC via a browser, actuates a FAX transmission function.

As described above, in a WWW server operable in a built-in apparatus, such as an image forming apparatus, URLs and process functions must be managed in a server program in such a way that the URLs are associated with the process functions. As a result, if all of such relations were managed in the WWW server, considerable workloads would be imposed on the WWW server, resulting in performance reduction.

On the other hand, if URLs are file-base managed like ordinary WWW servers, Web pages are determined based on only the URLs. In a WWW server in a built-in apparatus, however, process functions finally undertake display processes on Web pages, and thus there is room of availability of various controls based on information other than URLs. For example, limited access to Web pages based on information other than URLs can be adopted in such a way that while a Web page is displayed for a HTTPS request, the Web page is not displayed for a HTTP request. It is noted that HTTPS is HTTP having a security function in accordance with SSL (Secure Socket Layer). However, no mechanism to implement the above operation has been designed, including disclosure of Japanese Laid-Open Patent Application No. 10-173890.

### SUMMARY OF THE INVENTION

It is a general object of the present invention to provide a built-in apparatus, a HTTP request distribution method, a recording medium for storing a program to implement the method, and a Web system in which one or more of the above-mentioned problems are eliminated.

A more specific object of the present invention is to provide a built-in apparatus, a HTTP request distribution method, a recording medium for storing a program to implement the method, and a Web system that can not only prevent performance reduction by decreasing workloads on a server program due to association of URLs with process functions but also provide various controls based on information other than URL.

In order to achieve the above-mentioned objects, there is provided according to one aspect of the present invention a built-in apparatus having a WWW server function wherein a Web page is implemented as a process function, including: a first distribution part distributing a process corresponding to a HTTP request to a Web application associated with an application path of URL in the HTTP request; and a second distribution part distributing the process to a process function associated with a URL path of the URL in the Web application.

Additionally, there is provided according to another aspect of the present invention a method of distributing a HTTP request for a built-in apparatus having a WWW server function wherein a Web page is implemented as a process function, the method including steps of: distributing a process corresponding to a HTTP request to a Web application associated with an application path of URL in the HTTP request; and distributing the process to a process function associated with a URL path of the URL in the Web application.

Additionally, there is provided according to another aspect of the present invention a computer readable recording medium for storing a program to cause a computer to execute a procedure, the procedure including steps of distributing a process corresponding to a HTTP request to a Web application associated with an application path of URL in the HTTP request; and distributing the process to a process function associated with a URL path of the URL in the Web application.

Additionally, there is provided according to another aspect of the present invention a Web system having a built-in apparatus having a WWW server function and a plurality of clients wherein the built-in apparatus enables a Web page to be implemented as a process function and is connected to the plurality of clients via a network, including: a first distribution part distributing a process corresponding to a HTTP request to a Web application associated with an application path of URL in the HTTP request; and a second distribution part distributing the process to a process function associated with a URL path of the URL in the Web application.

According to one aspect of the present invention, it is possible to not only prevent performance reduction by decreasing workloads on a server program due to association of URLs with process functions but also provide various controls based on information other than URL.

Other objects, features and advantages of the present invention will become more apparent from the following detailed description when read in conjunction with the accompanying drawings.

### BRIEF DESCRIPTION OF THE DRAWINGS

FIG. 1 is a block diagram illustrating an exemplary structure of an image processing system having an image forming apparatus according to an embodiment of the present invention;

FIG. 2 is a block diagram illustrating an exemplary functional structure of the image forming apparatus according to an embodiment of the present invention;

FIG. 3 is a block diagram illustrating an exemplary hardware configuration of the image forming apparatus according to an embodiment of the present invention;

FIG. 4 is a block diagram illustrating an exemplary module structure of a Web application according to an embodiment of the present invention;

FIG. 5 is a block diagram illustrating an exemplary functional structure relate to process distribution of a HTTP daemon and a Web application according to an embodiment of the present invention;

FIG. 6 is a diagram to explain an application path and a URL path according to an embodiment of the present invention;

FIG. 7 is a block diagram illustrating an exemplary detailed functional structure of the Web application shown in FIG. 5;

FIG. 8 is a block diagram illustrating an exemplary functional structure of functions related to acquisition of port identifiers by the HTTP daemon according to an embodiment of the present invention;

FIG. 9 is a flowchart of an exemplary operation of the Web application and the HTTP daemon to distribute processes;

FIG. 10 is a sequence diagram illustrating the distribution operation shown in FIG. 9;

FIG. 11 is a detailed flowchart of the second distribution operation performed by the Web application 21;

FIG. 12 is a sequence diagram illustrating the second distribution operation shown in FIG. 11; and

FIG. 13 is a sequence diagram illustrating an exemplary operation of an initialization function according to an embodiment of the present invention.

### DETAILED DESCRIPTION OF THE PREFERRED EMBODIMENTS

In the following, embodiments of the present invention will be described with reference to the accompanying drawings.

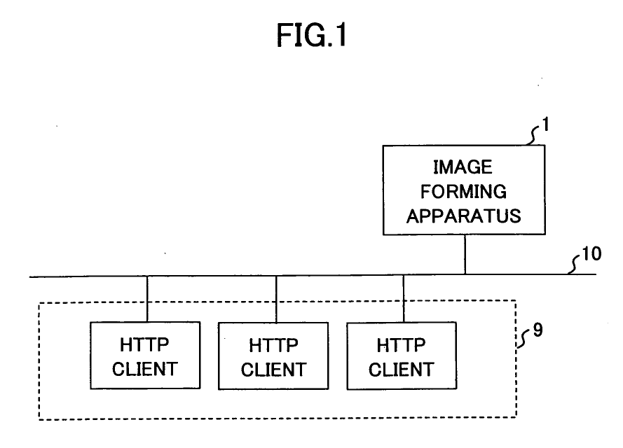

FIG. 1 is a block diagram illustrating an exemplary structure of an image processing system having an image forming apparatus according to an embodiment of the present invention. In this embodiment, the image forming apparatus is implemented as a so-called “multifunction peripheral (MFP)” that accommodates separate functions, such as a printer, a copier, a facsimile and a scanner, into one housing.

Referring to FIG. 1, in the image processing system, an image forming apparatus 1 is connected to a plurality of HTTP clients 9 via a network 10 such as LAN (Local Area Network), an intranet and the Internet.

The image forming apparatus 1, in response to receipt of requests from the HTTP clients 9, can print document data or FAX-transmit data. In addition, the image forming apparatus 1, in response to HTTP requests from the HTTP clients 9, can transmit to the HTTP clients 9 Web pages for displaying information requested by the HTTP requests. For example, if a user of a HTTP client 9 requests status information on the image forming apparatus 1 via a Web browser, the image forming apparatus 1 sends HTML (HyperText Markup Language) data having the status information to the HTTP client 9. In this embodiment, the HTTP client 9 may be PC, PDA (Personal Digital Assistant) or a cellular phone. Also, the HTTP client 9 has a Web browser to display Web pages delivered from the image forming apparatus 1.

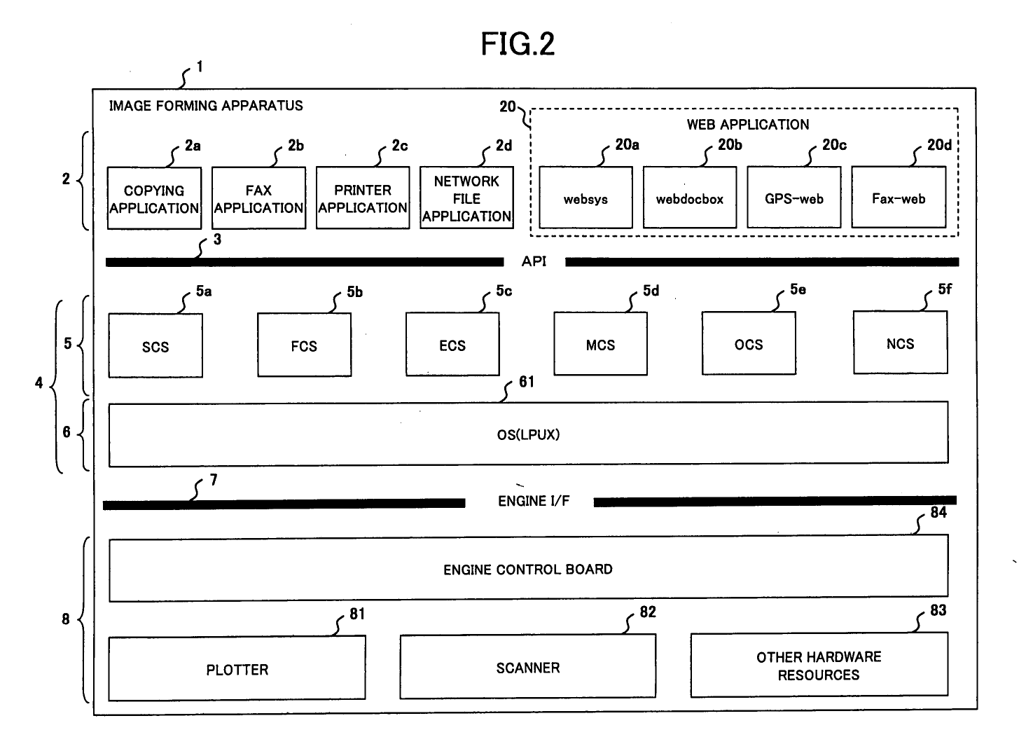

FIG. 2 is a block diagram illustrating an exemplary functional structure of the image forming apparatus 1 according to an embodiment of the present invention.

Referring to FIG. 2, the image forming apparatus 1 includes an application layer 2, a platform layer 4 and an engine part 8. The platform layer 4 includes two interfaces 3 and 8: the interface (API) 3 to the application layer 2 and the interface (engine I/F) 8 to the engine part 8.

The application layer 2 includes software items to perform separate functions of the image forming apparatus 1. The application layer 2 is composed of a copying application 2a to implement a copying function, a FAX application 2b to implement a FAX function, a printer application 2c to implement a print function and a network file application 2d to implement a function to exchange files via a network. The application layer 2 further includes a Web application 20 having application items to implement Web services in accordance with HTTP protocol. The Web application 20 is composed of Web application items “websys” 20a, “webdocbox” 20b, “GPS-web” 20c and “Fax-web” 20d. The Web application item “websys” 20a enables a user to view the status of the image forming apparatus 1 via a Web browser and set network configuration of the image forming apparatus 1. The Web application item “webdocbox” 20b uses the network file application 2d to exchange and manage documents via a Web browser. The Web application item “GPS-web” 20c displays job history (spool status) of a printer component of the image forming apparatus 1. The Web application item “Fax-web” 20d displays initial configuration and communication management report (communication history) of a FAX component of the image forming apparatus 1 in form of tables.

The platform layer 4 includes software items to provide common service functions to application items of the application layer 2 via the interface 3. The platform layer 4, if broadly divided, is composed of a service layer 5 and an OS layer 6. The service layer 5 includes SCS (System Control Service) 5a, FCS (FAX Control Service) 5b, ECS (Engine Control Service) 5c, MCS (Memory Control Service) 5d, OCS (Operation panel Control Service) 5e and NCS (Network Control Service) 5f. SCS 5a implements a plurality of functions: application management, operation part control, system screen display, LED display, resource management, interrupt control and so on. FCS 5b provides API (Application Programming Interface) of FAX functions. ECS 5c controls the engine part 8. MCS 5d controls memories of the image forming apparatus 1. OCS 5e controls an operation part (operation panel), which works as an interface to an operator, of the image forming apparatus 1. NCS 5f provides common services that application items can use in common to input/output data via a network. The OS layer 6 includes OS (LPUX) 61.

The engine-part 8 includes some engines, such as a plotter 81, a scanner 82 and other hardware resources 83, and an engine control board 84 to control these engines.

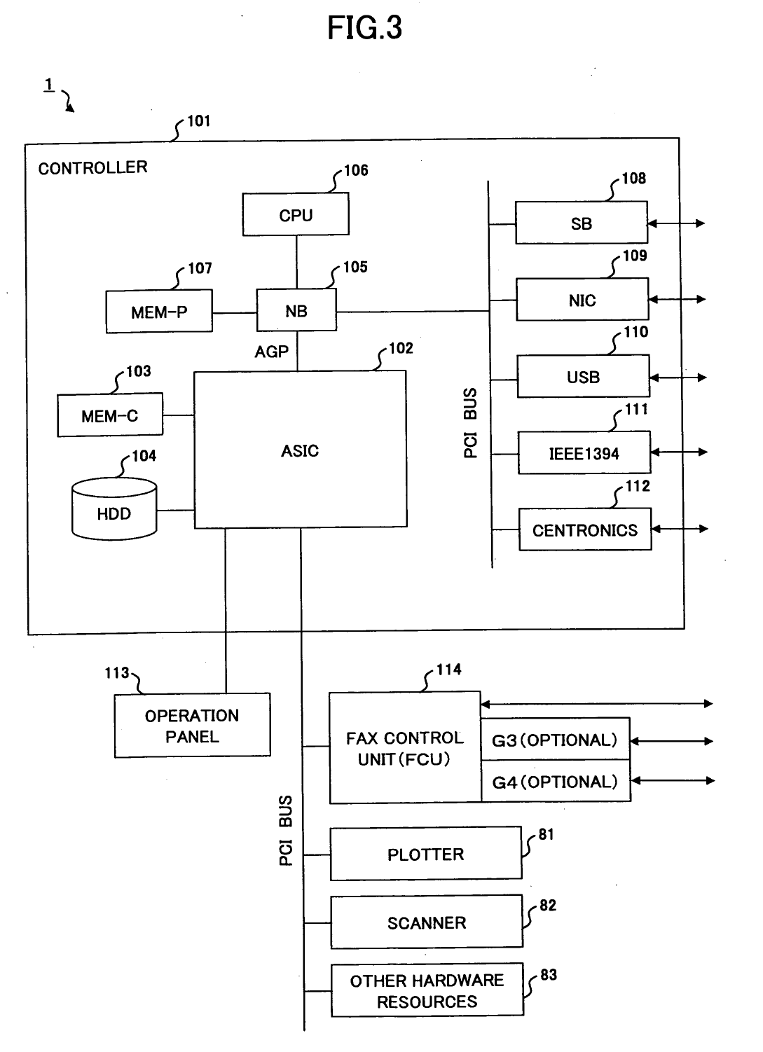

FIG. 3 is a block diagram illustrating an exemplary hardware configuration of the image forming apparatus 1 according to an embodiment of the present invention.

Referring to FIG. 3, the image forming apparatus 1 is configured in such a way that a controller 101 to control operations of the image forming apparatus 1 is connected to an operation panel 113, a FAX control unit (FCU) 114, the plotter 81, the scanner 82 and the other hardware resources 83.

In the controller 101, ASIC (Application Specific Integrated Circuit), which is an image processing dedicated IC, is connected to CPU (Central Processing Unit) 106, which is a general-purpose control IC, via NB (North Bridge) 105. Also, a PCI bus of NB 105 is connected to SB (South Bridge) 108 connectable to peripheral devices, NIC 109 to control network communication, USB 110 to provide a USB interface, IEEE1394 111 to provide an IEEE1394 interface, and a centronics 112 to provide a centronics interface. Moreover, ASIC 102 is connected to MEM-C 103 and HDD 104 as storage devices. NB 105 is connected to MEM-P 107 as a storage device.

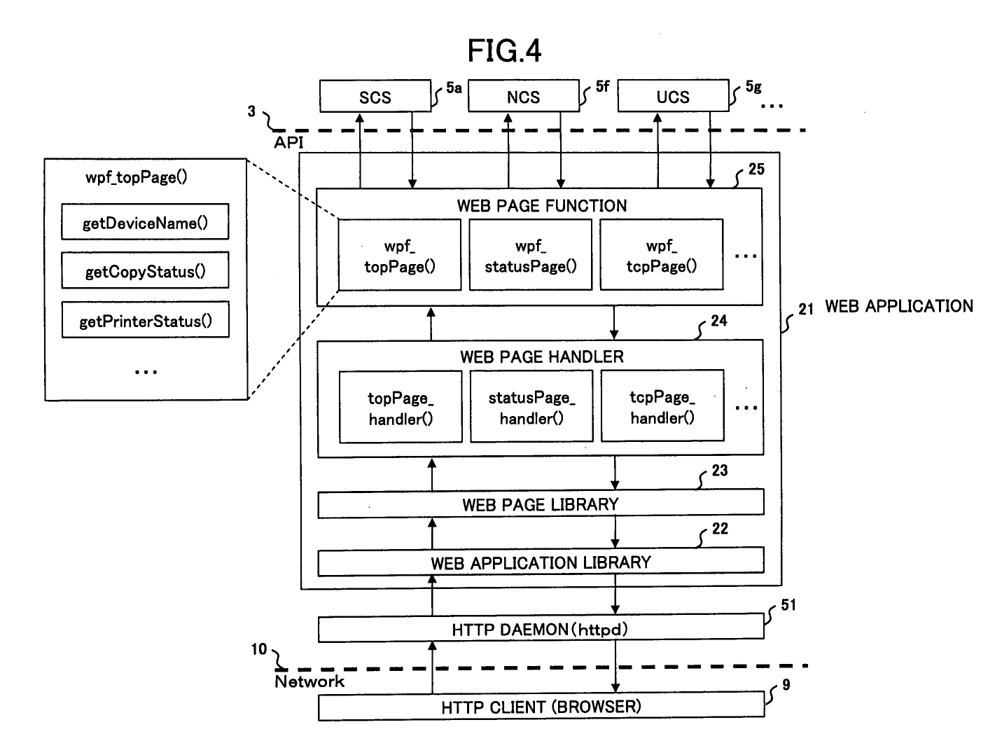

FIG. 4 is a block diagram illustrating an exemplary module structure of a Web application according to an embodiment of the present invention.

Referring to FIG. 4, a Web application 21 is connected to a HTTP daemon (httpd) 51, which implements a portion of functions of NCS 5f in FIG. 2, so as to distribute HTTP requests received from a HTTP client 9, such as a Web browser, via the network 10 and return process results (HTML, XML and TEXT) of the Web application 21. The Web application 21 includes a Web application library 22 and a Web page library 23, which are frameworks to develop Web applications to provide various common functions, a Web page handler 24 to handle Web pages, and a Web page function 25 to perform actual actions related to Web page display. Process functions to implement Web pages are configured from the Web page handler 24 and the Web page function 25. When the Web page function 25 performs processes, the Web page function 25 communicates to SCS 5a, NCS 5f, UCS 5g or the like via the interface 3.

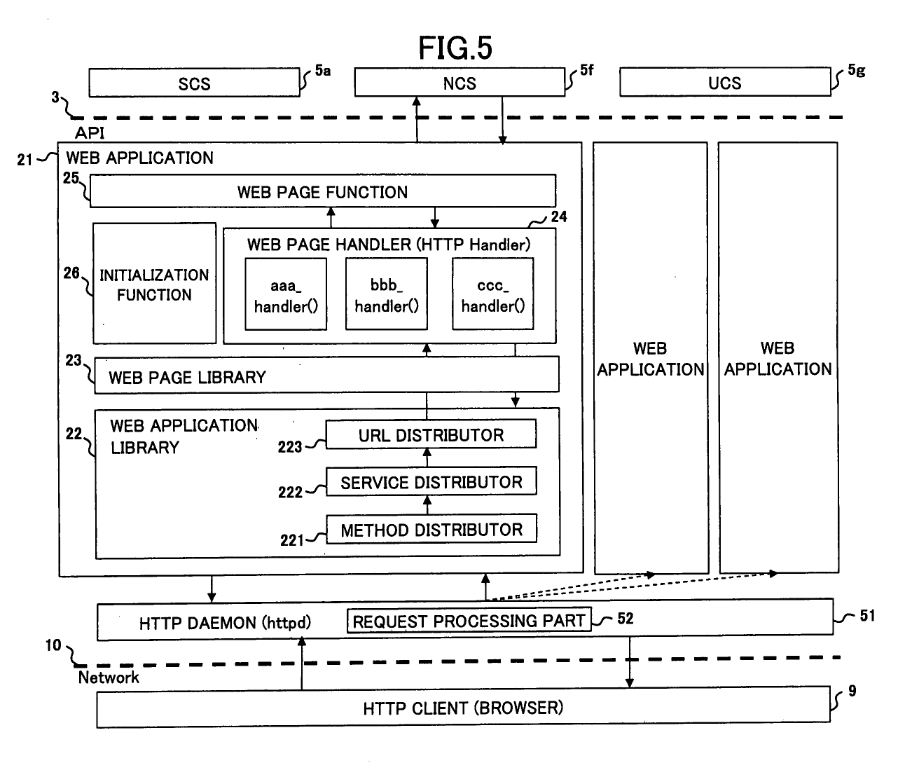

FIG. 5 is a block diagram illustrating an exemplary functional structure related to process distribution of the HTTP daemon 51 and the Web application 21 according to an embodiment of the present invention.

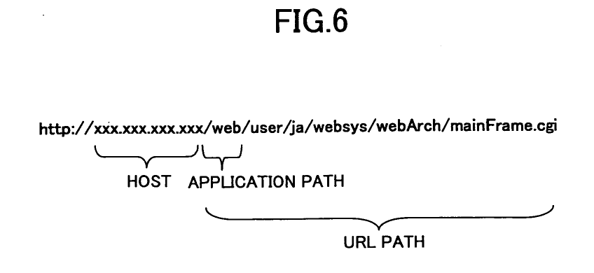

Referring to FIG. 5, the HTTP daemon 51 includes a request processing part 52 to distribute processes to corresponding Web applications based on application paths in HTTP requests received from the HTTP clients 9 and generate port identifiers indicative of used services (HTTP, HTTPS and so on). The term “application path” used herein represents, as shown in FIG. 6, if a HTTP request has “http://xxx.xxx.xxx.xxx/web/user/ja/websys/webArch/mainf rame.cgi”, the “web” portion corresponding to one layer after the host “xxx.xxx.xxx.xxx”. Also, the term “URL path” described below means the “web/user/ja/websys/webArch/mainframe.cgi” including the application path.

Referring back to FIG. 5, the Web application library 22 of the Web application 21 includes a method distributor 221, a service distributor 222 and a URL distributor 223. The method distributor 221 distributes processes corresponding to methods (GET, POST or the like) of HTTP requests received from the HTTP clients 9. The service distributor 222 distributes processes corresponding to used services (HTTP, HTTPS or the like) based on port identifiers generated by the HTTP daemon 51. The URL distributor 223 distributes processes corresponding to URL paths of HTTP requests.

The Web application 21 further includes an initialization function 26 to perform initialization processes, such as table creation, on the method distributor 221, the service distributor 222, the URL distributor 223 and so on. The other components of the Web application 21 are similar to those shown in FIG. 4. Also, other Web applications have the same structure as the Web application 21.

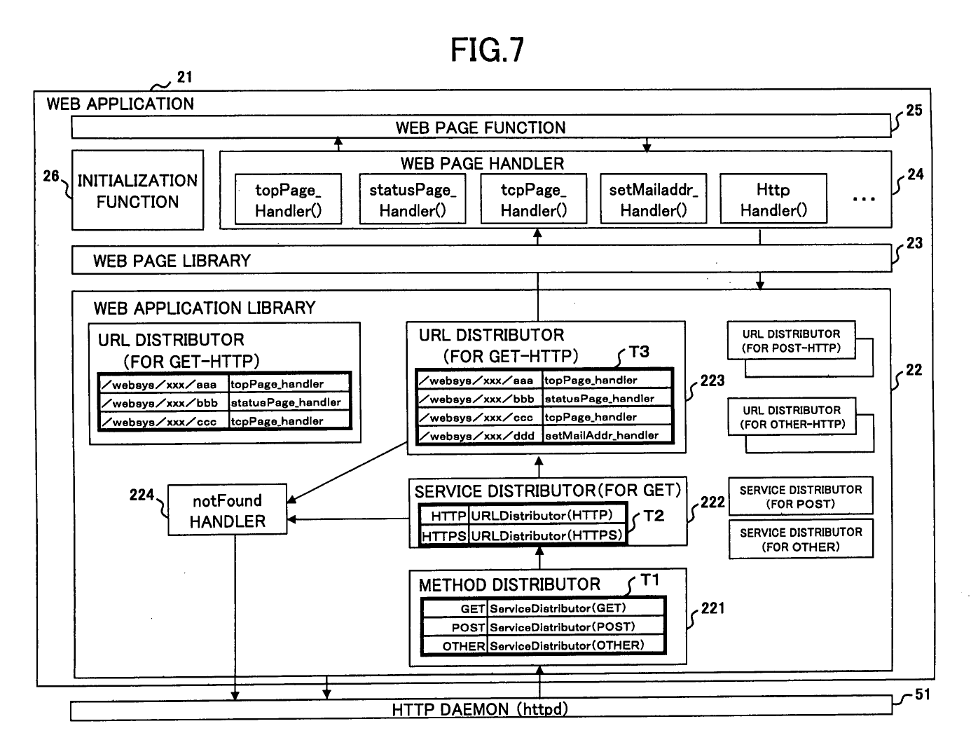

FIG. 7 is a block diagram illustrating an exemplary detailed functional structure of the Web application 21 shown in FIG. 5.

Referring to FIG. 7, the method distributor 221 includes a method table T1 having a correspondence between methods of HTTP requests and service distributors. Also, the service distributor 222 includes a service table T2 having a correspondence between used services and URL distributors. Other service distributors are provided likewise for individual services. Moreover, the URL distributor 223 includes a URL table T3 having a correspondence between URL paths and Web page handlers 24. Other URL distributors are provided likewise for individual services and URL paths.

Furthermore, the Web application library 22 further includes a “notFound” handler 224 to reply display information indicating that there is no relevant page. The other components of the Web application 21 are similar to those shown in FIG. 5.

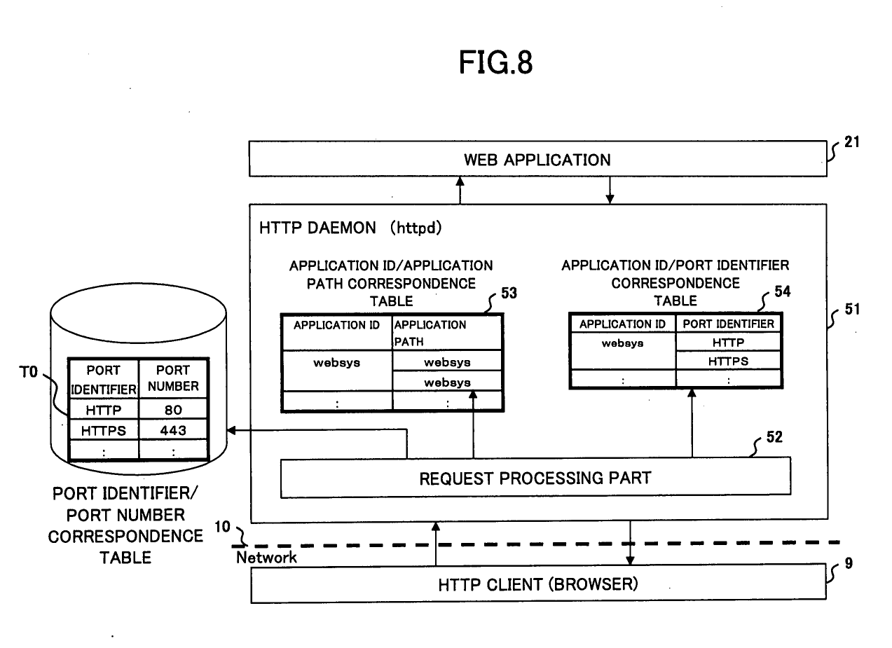

FIG. 8 is a block diagram illustrating an exemplary functional structure of functions related to acquisition of port identifiers by the HTTP daemon 51 according to an embodiment of the present invention.

Referring to FIG. 8, the HTTP daemon 51 includes an application ID/application path correspondence table 53 having a correspondence between application IDs and application paths and an application ID/port identifier correspondence table 54 having a correspondence between application IDs and port identifiers. The request processing part 52 can acquire a port identifier from a port identifier/port number correspondence table T0 having a correspondence between port identifiers and port numbers, and compare the acquired port identifier to port identifiers listed in the application ID/port identifier correspondence table 54. Then, the request processing part 52 allocates the acquired port identifier to a HTTP request, and delivers the HTTP request to a Web application to be distributed.

Exemplary operation of the image forming apparatus 1 according to this embodiment is described.

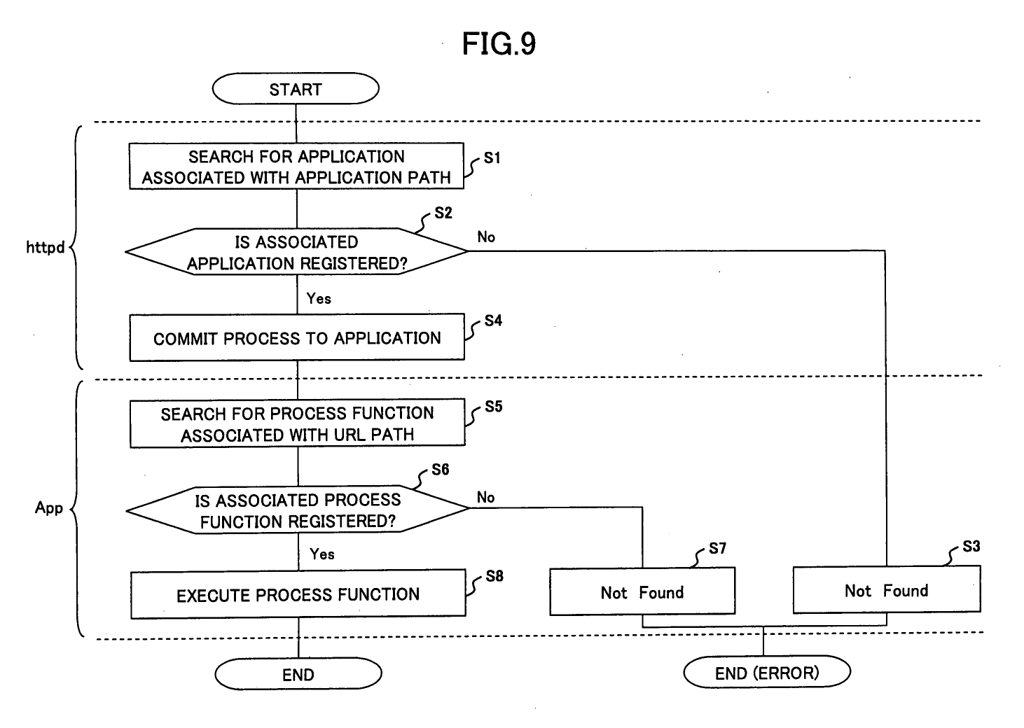

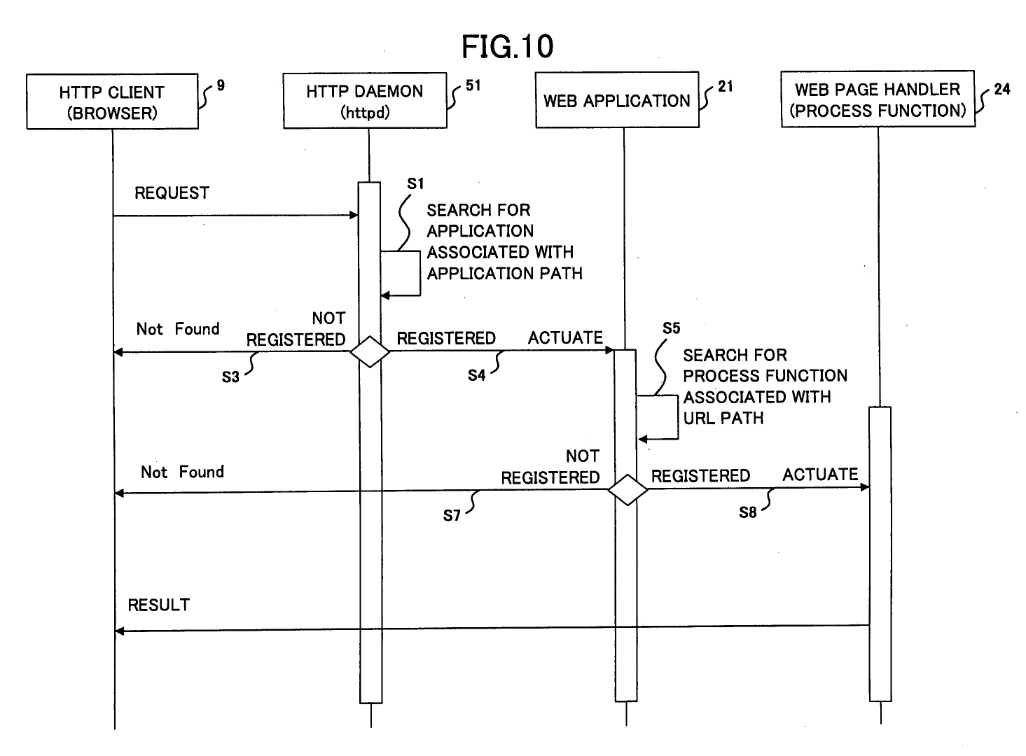

FIG. 9 is a flowchart of an exemplary operation of the Web application 21 and the HTTP daemon 51 to distribute processes. FIG. 10 is a sequence diagram illustrating the distribution operation shown in FIG. 9.

Referring to FIG. 9 and FIG. 10, the HTTP daemon (httpd) 51, in response to receipt of a HTTP request from a HTTP client 9, searches a registration table for a Web application associated with an application path being a portion of URL in the HTTP request at step S1.

If the associated Web application is not registered (S2: No), the HTTP daemon 51 actuates the notFound handler 224 to reply an error response (NotFound) to the HTTP client 9 at step S3, and the distribution operation is terminated.

On the other hand, if the associated Web application is registered (S2: Yes), the HTTP daemon 51 delivers the HTTP request to the found Web application 21 to commit the process corresponding to the HTTP request at step S4. This action corresponds to a first distribution operation performed by the HTTP daemon 51.

Then, the Web application 21 searches a registration table for a process function (Web page handler) associated with the URL path at step S5.

If the associated process function is not registered (S6: No), the Web application 21 actuates the notFound handler 224 to reply an error response (NotFound) to the HTTP client 9 at step S7, and the distribution operation is terminated.

On the other hand, if the associated process function is registered (S6: Yes), the Web application 21 executes the found process function at step S8, and then the distribution operation is terminated. This action corresponds to a second distribution operation performed by the Web application 21.

In this manner, the HTTP daemon 51 only has to perform the first distribution operation to distribute a process to a Web application associated with the process. Then, the Web application 21 performs the second distribution operation to distribute the process to a process function associated with the process. As a result, it is possible to prevent performance reduction due to increase in workloads on the HTTP daemon 51, which works as a server program, to associate URL with the process function.

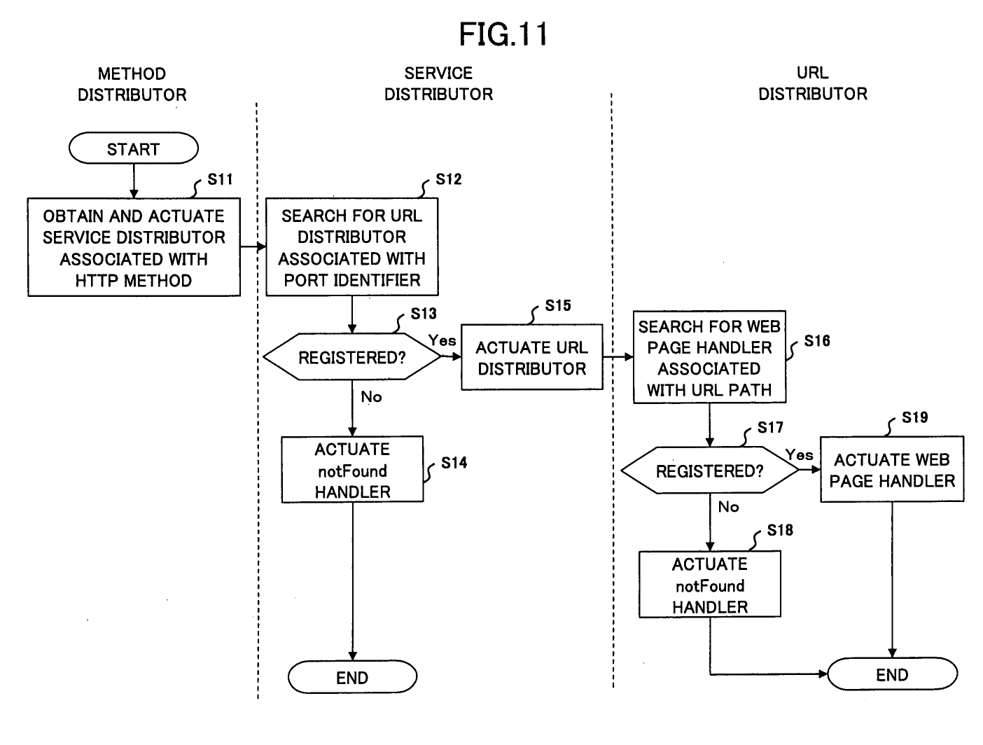

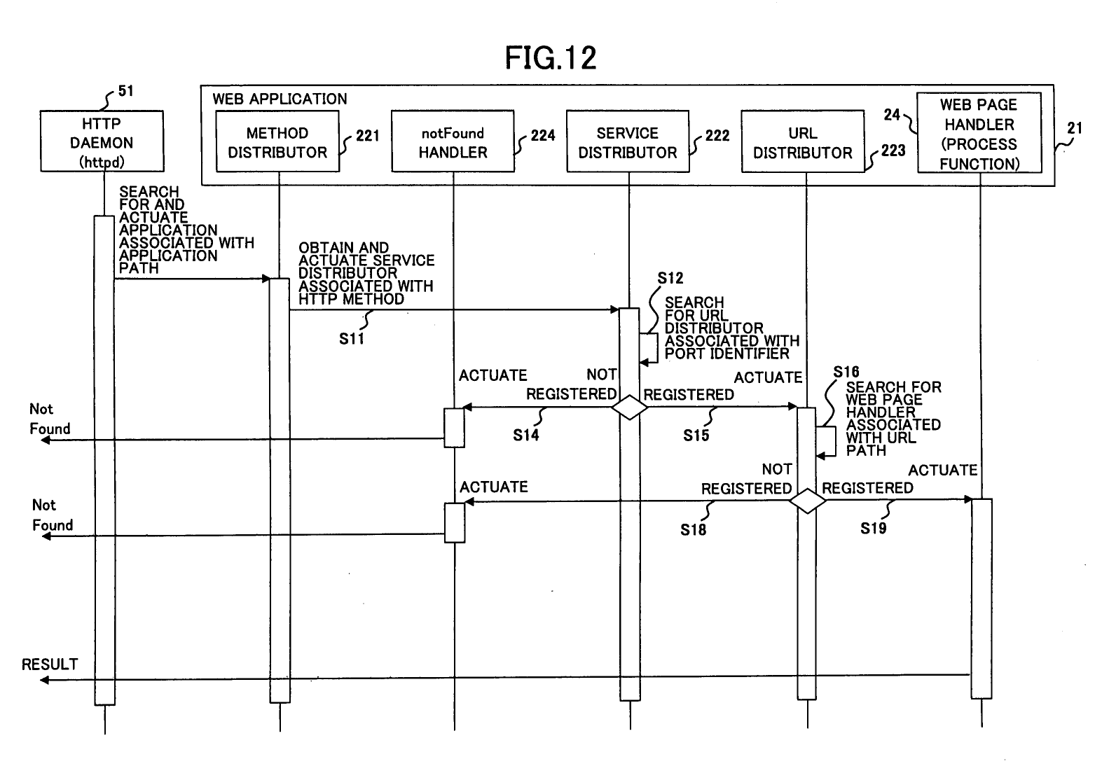

FIG. 11 is a detailed flowchart of the second distribution operation performed by the Web application 21. FIG. 12 is a sequence diagram illustrating the second distribution operation shown in FIG. 11.

Referring to FIG. 11 and FIG. 12, the method distributor 221, in response to receipt of a HTTP request, obtains and actuates a service distributor 222 associated with a HTTP method obtained from a HTTP header of the HTTP request at step S11. Specifically, the method distributor 221 searches the method table T1 shown in FIG. 7 for the service distributor 222 by using methods as the search key.

The actuated service distributor 222 searches for a URL distributor associated therewith based on a service (service indicated in a port identifier) of the request information at step S12. Specifically, the service distributor 222 searches the service table T2 shown in FIG. 7 for the URL distributor by using services (port identifiers) as the search key.

If the associated URL distributor is not registered (S13: No), the service distributor 222 actuates the notFound handler 224 to reply an error response to the HTTP client 9 at step S14, and then the distribution operation is terminated.

On the other hand, if the associated URL distributor is registered (S13: Yes), the service distributor 222 actuates the found URL distributor 223 at step S15.

At step S16, the actuated URL distributor 223 searches for a Web page handler (process function) associated therewith based on a URL path of the request information. Specifically, the URL distributor 223 searches the URL table T3 shown in FIG. 7 for the Web page handler by using URL paths as the search key.

If the associated Web page handler is not registered (S17: No), the URL distributor 223 actuates the notFound handler 224 to replay an error response to the HTTP client 9 at step S18, and then the distribution operation is terminated.

On the other hand, if the associated Web page handler is registered (S17: Yes), the URL distributor 223 actuates the found Web page handler 24, and then the distribution operation is terminated.

In this manner, the Web application 21 performs the second distribution operation to distribute a process to a process function (Web page handler) based on methods, services (port identifiers) and URL paths. As a result, it is possible to not only properly associate URLs in a WWW server in a built-in apparatus with process functions but also control various page accesses. For example, it is possible to control the built-in apparatus in such a way that while pages are displayed for HTTPS requests, no page is displayed for HTTP requests.

Although methods, services (port identifiers) and URL paths are used as distribution indicators in this embodiment, content types, languages, user agents or the like may be used as the distribution indicators.

An exemplary initialization operation of distribution information, which is actuated in response to start of the system, is described.

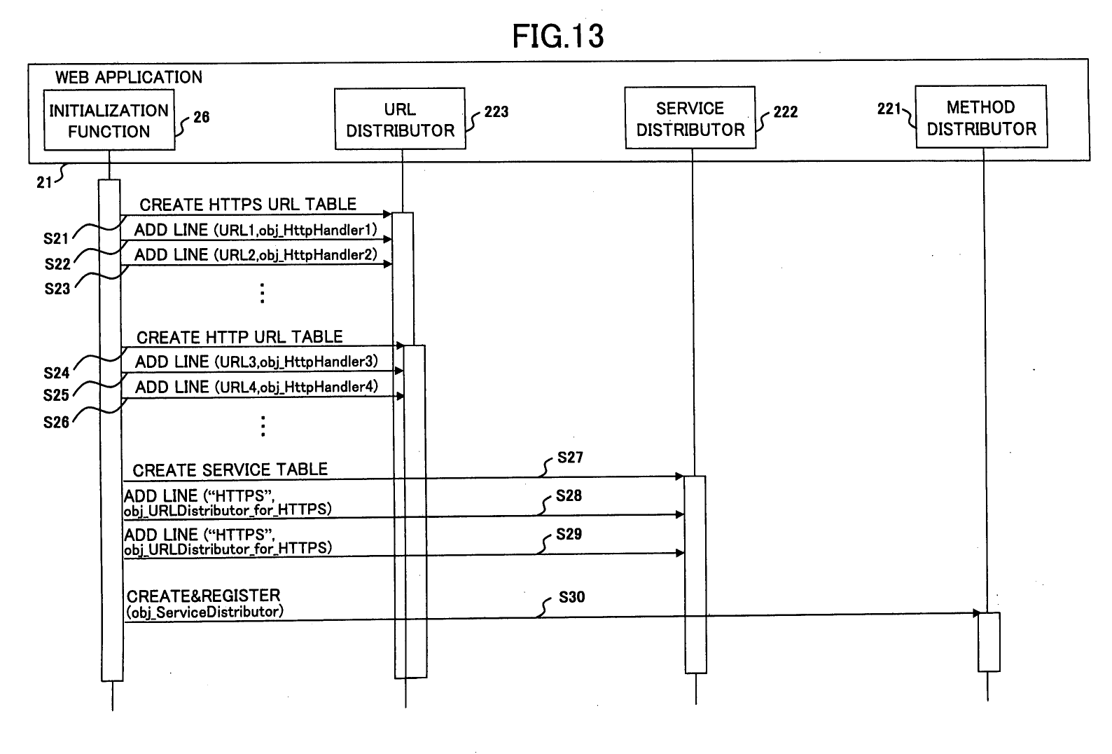

FIG. 13 is a sequence diagram illustrating an exemplary operation of an initialization function according to an embodiment of the present invention. In this embodiment, HTTPS and HTTP are set as registered services.

Referring to FIG. 13, an initialization function 26 of the Web application 21, in response to start of an initialization operation, creates a HTTPS URL table T3 at step S21, and registers a process function associated with a URL path of a Web page displayed for the HTTPS request together with the association in the HTTPS URL table T3 at steps S22 and S23.

At step S24, the initialization function 26 creates a HTTP URL table T3 likewise, and registers a process function associated with a URL path of a Web page displayed for the HTTP request together with the association in HTTP URL table T3 at steps S25 and S26.

At step S27, the initialization function 26 creates a service table T2, and registers a correspondence between services and URL distributors at steps S28 and S29.

At step S30, the initialization function 26 creates a method table T1, and registers a correspondence between methods and service distributors. It is noted that the method table T1 and the method distributor 221 are under management of a system (HTTP connection manager) to control communication.

In this manner, the method table T1, the service table T2 and the URL table T3 in use for a distribution operation are created in the initialization operation at start of the system.

The present invention is not limited to the specifically disclosed embodiments, and variations and modifications may be made without departing from the scope of the present invention.

The present application is based on Japanese Patent Priority Application No. 2003-329078 filed Sep. 19, 2003, the entire contents of which are hereby incorporated by reference.

1. A built-in apparatus having a WWW server function wherein a Web page is implemented as a process function, comprising:
a first distribution part distributing a process corresponding to a HTTP request to a Web application associated with an application path of URL in the HTTP request; and
a second distribution part distributing the process to a process function associated with a URL path of the URL in the Web application.

2. The built-in apparatus as claimed in claim 1, wherein the first distribution part is implemented by a HTTP daemon.

3. The built-in apparatus as claimed in claim 1, wherein the second distribution part is implemented by at least one library in the Web application.

4. The built-in apparatus as claimed in claim 3, wherein the second distribution part is implemented by one or more URL distributors in the at least one library based on a URL table having a correspondence between one or more URL paths and one or more process functions.

5. The built-in apparatus as claimed in claim 4, wherein the library comprises one or more service distributors distributing the process in association with a service designated in the HTTP request based on a service table having a correspondence between one or more port identifiers to identify one or more services and the one or more URL distributors.

6. The built-in apparatus as claimed in claim 5, wherein the library comprises one or more method distributors distributing the process in association with a service designated in the HTTP request based on a method table having a correspondence between one or more methods and the one or more service distributors.

7. The built-in apparatus as claimed in claim 5, wherein the one or more port identifiers are generated by a HTTP daemon.

8. The built-in apparatus as claimed in claim 7, wherein the one or more port identifiers are obtained from a port identifier/port number correspondence table to manage the one or more port identifiers and one or more port numbers in an associated form.

9. The built-in apparatus as claimed in claim 6, further comprising:
an initialization function creating the URL table, the service table and the method table at system start time and registering values in the URL table, the service table and the method table.

10. The built-in apparatus as claimed in claim 1, further comprising:
a notFound handler replying an error in case of a relevant Web page being not displayed.

11. A method of distributing a HTTP request for a built-in apparatus having a WWW server function wherein a Web page is implemented as a process function, the method comprising steps of:
distributing a process corresponding to a HTTP request to a Web application associated with an application path of URL in the HTTP request; and
distributing the process to a process function associated with a URL path of the URL in the Web application.

12. A computer readable recording medium for storing a program to cause a computer to execute a procedure, the procedure comprising steps of
distributing a process corresponding to a HTTP request to a Web application associated with an application path of URL in the HTTP request; and
distributing the process to a process function associated with a URL path of the URL in the Web application.

13. A Web system having a built-in apparatus having a WWW server function and a plurality of clients wherein the built-in apparatus enables a Web page to be implemented as a process function and is connected to the plurality of clients via a network, comprising:
a first distribution part distributing a process corresponding to a HTTP request to a Web application associated with an application path of URL in the HTTP request; and
a second distribution part distributing the process to a process function associated with a URL path of the URL in the Web application.
